(19) United States
(12) Patent Application Publication
(10) Pub. No.: US 2026/0259993 A1
(43) Pub. Date: Sep. 3, 2026

(54) SYSTEM AND METHOD OF USING ARTIFICIAL INTELLIGENCE TO PRIORITIZE SECURITY RISKS IN A SOFTWARE DEVELOPMENT SYSTEM

(71) Applicant: DELL PRODUCTS L.P., Round Rock, TX (US)

(72) Inventors: Parminder Singh Sethi, Ludhiana (IN); Tamilarasan Janakiraman, Cork (IE); Avinash Kumar, Patna (IN); Praveen Kumar, Noida (IN)

(21) Appl. No.: 19/067,856

(22) Filed: Mar. 1, 2025

(51) Int. Cl. G06F 21/57

(52) U.S. Cl. CPC G06F 21/577; G06F 2221/033

(57) ABSTRACT

An information handling system includes a computer readable medium having an artificial intelligence (AI) application security model. The system further includes a processor operably coupled to the computer readable medium to access the AI application security model to gather business information for one or more applications, gather application vulnerability data, flag one or more at risk applications based on the vulnerability data, and assign a business vulnerability score for the one or more at risk application at least partially based on the business information for the one or more at risk application.

### FIELD OF THE DISCLOSURE

The present disclosure generally relates to software development systems, and more particularly relates to protecting software applications from security risks during development.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a computer readable medium having an artificial intelligence (AI) application security model. The system further includes a processor operably coupled to the computer readable medium to access the AI application security model to gather business information for one or more applications, gather application vulnerability data, flag one or more at risk applications based on the vulnerability data, and assign a business vulnerability score for the one or more at risk application at least partially based on the business information for the one or more at risk application.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an application development system according to an embodiment of the present disclosure;

FIG. 2 is a block diagram of an information handling system according to an embodiment of the present disclosure;

FIG. 3 is a flow diagram of a method of using artificial intelligence to prioritize security risks in a software development system; and

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

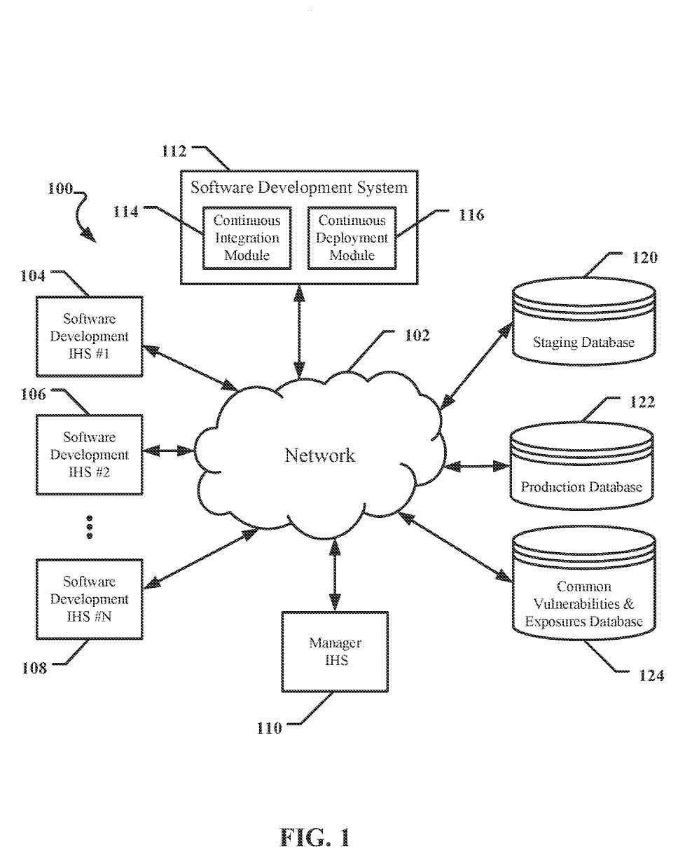

Referring initially to FIG. 1, an application development system is shown and is generally designated 100. As shown, the application development system 100 may include a network 102, e.g., a wireless network or a wired network. A first software development information handling system (IHS) 104 is operably coupled to the network 102. Further, a second software development information handling system 106 is operably coupled to the network 102. FIG. 1 also shows an Nth software development information handling system 108 that is operably coupled to the network 102. Accordingly, the application development system 100 may include any number of software development information handling systems.

As further shown, the application development system 100 may include a manger information handling system 110 coupled to the network 102. The application development system 100 also includes a software development system 112 operably coupled to the network 102. The software development system 112 includes a continuous integration module 114 and a continuous deployment module 116. As such, the software development system 112 is a continuous integration/continuous deployment (CI/CD) system. FIG. 1 further shows that the system 100 includes a staging database 120 connected to the network 102. The staging database 120 can include one or more applications that are in the staging phase. The system 100 may also include a production database 122 connected to the network 102. The production database 122 can include one or more applications that are in the production phase. Finally, the system 100 may include a common vulnerabilities and exposures (CVE) database 124 that is operably coupled to the network 102. The CVE database 124 may be an external database that includes known CVEs (updated frequently) and their associated common vulnerability scoring system (CVSS) scores.

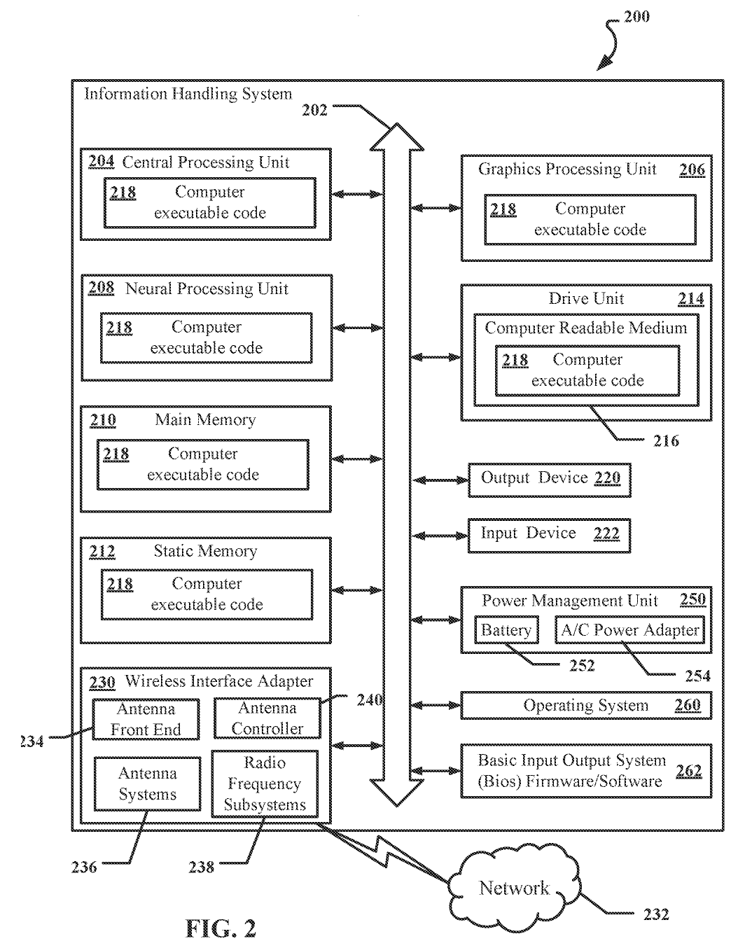

FIG. 2 illustrates an information handling system 200 having various components disposed therein. For purposes of this disclosure, the information handling system 200 may include any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, the information handling system 200 can be a personal computer, a mobile device (e.g., a personal digital assistant (PDA) or a smart phone), server (e.g., a blade server or a rack server), a consumer electronic information handling system, a network server or storage device, a network router, switch, or bridge, wireless router, or other network communication information handling system, a network connected device (cellular telephone, tablet information handling system, etc.), IoT computing device, wearable computing device (e.g., a smart watch or smart glasses), a set-top box (STB), a mobile device, a palmtop computer, a laptop computer, a desktop computer, a communications device, an access point (AP), a base station transceiver, a wireless telephone, a land-line telephone, a control system, a camera, a scanner, a facsimile machine, a printer, a pager, a personal device, a web appliance, or any other suitable machine capable of executing a set of instructions (sequential or otherwise) that specify actions to be taken by that machine, and can vary in size, shape, performance, price, and functionality.

In a networked deployment, for example, the information handling system 200 may operate in the capacity of a server or as a client computer in a server-client network environment, or as a peer computer system in a peer-to-peer (or distributed) network environment. In a particular embodiment, the information handling system 200 can be implemented using electronic information handling systems that provide voice, video or data communication. For example, an information handling system 200 may be any mobile or other computing device capable of executing a set of instructions (sequential or otherwise) that specify actions to be taken by that machine. Further, while a single information handling system 200 is illustrated, the term “system” shall also be taken to include any collection of systems or sub-systems that individually or jointly execute a set, or multiple sets, of instructions to perform one or more computer functions.

In general, the information handling system 200 can include memory (volatile (e.g., random-access memory, etc.), nonvolatile (read-only memory, flash memory etc.) or any combination thereof), one or more processing resources, such as a central processing unit (CPU), a graphics processing unit (GPU), a neural processing unit (NPU), hardware or software control logic, or any combination thereof. Additional components of the information handling system 200 can include one or more storage devices, one or more communications ports for communicating with external devices, as well as, various input and output (I/O) devices, such as a keyboard, a mouse, a video/graphic display, or any combination thereof. The information handling system 200 can also include one or more buses operable to transmit communications between the various hardware components. Portions of an information handling system 200 may themselves be considered information handling systems 200. The information handling system 200 can include devices or modules that embody one or more of the devices or execute instructions for the one or more systems and modules described herein, and operates to perform one or more of the methods described herein.

As illustrated in FIG. 2, in particular, the information handling system 200 can include one or more buses 202 operable to transmit communications between the various hardware components such as any combination of various input and output (I/O) devices described herein. The information handling system 200 can include one or more processors operably coupled to the bus 202. For example, the information handling system 200 can include a central processing unit (CPU) 204, a graphics processing unit (GPU) 206, a neural processing unit (NPU) 208, or any combination thereof. The CPU 204, the GPU 206, and the NPU 208 may include control logic and may individually, or collectively, operate to execute code that is either firmware or software code. Moreover, the information handling system 200 can include one or more memory devices such as a main memory 210, a static memory 212, and a drive unit 214 having a computer readable medium 216 disposed therein. The drive unit 214 can include a hard drive unit, a solid state drive unit, or a combination thereof. Further, the various memory devices 210, 212, 214, 216 may include volatile memory (e.g., random-access memory, etc.), nonvolatile memory (read-only memory, flash memory etc.) or any combination thereof).

The information handling system 200 includes computer executable code 218 that may reside on, or be executed by, the CPU 204, the GPU 206, the NPU 208, the main memory 210, the static memory 212, the computer readable medium 216 of the drive unit 214, or any combination thereof. The computer executable code 218 can include instructions (e.g., software algorithms), parameters, and profiles. The computer executable code 218 that may operate on servers or systems, remote data centers, or on-box in individual client information handling systems according to various embodiments herein. In some embodiments, it is understood any or all portions of the computer executable code 218 may operate on, or be executed by, the CPU 204, the GPU 206, the NPU 208, the main memory 210, the static memory 212, the computer readable medium 216 of the drive unit 214, or any combination thereof. In some embodiments, it is understood any or all portions of computer executable code 218 may operate on a plurality of information handling systems 200.

As shown, the information handling system 200 may further include an output device 220, e.g., a video display output. In an embodiment, the output device 220 may include a liquid crystal display (LCD), an organic light emitting diode (OLED), a flat panel display, a solid-state display, a curved panel display, a flexible panel display, or a combination thereof. Further, the output device 220 may include one or more sound output devices, e.g., speakers. As further illustrated, the information handling system 200 may include an input device 222 that may include an alpha numeric input device, such as a keyboard, and/or a cursor control device, such as a mouse, touchpad, or gesture or touch screen input device.

The information handling system 200 may also include a network interface device, shown as a wireless interface adapter 230, that can provide connectivity to a network 232, e.g., a wide area network (WAN), a local area network (LAN), wireless local area network (WLAN), a wireless personal area network (WPAN), a wireless wide area network (WWAN), or another network. In an embodiment, the WAN, WWAN, LAN, and WLAN may each include an access point used to operatively coupled the information handling system 200 to a network. In a specific embodiment, the network 254 may include macro-cellular connections via one or more base stations, one or more wireless access points (e.g., Wi-Fi or WiGig), one or more licensed or unlicensed WWAN small cell base stations, or a combination thereof. Further, network connectivity may be a wired or wireless connection.

As depicted, the wireless interface adapter 230 may include an antenna front end 234, one or more antenna systems 236, one or more radio frequency subsystems 238, and an antenna controller 240. These components may include transmitter/receiver circuitry, modem circuitry, one or more radio frequency front end circuits, one or more wireless controller circuits, amplifiers, and other circuitry of the wireless interface adapter, such as one or more antenna ports used for wireless communications via multiple radio access technologies. Each radio frequency subsystem 234 may communicate with one or more wireless technology protocols. The radio frequency subsystem 234 may contain individual subscriber identity module (SIM) profiles for each technology service provider and their available protocols for any operating subscriber-based radio access technologies such as cellular LTE communications.

In some embodiments of the present disclosure, the wireless interface adapter 230 may operate two or more wireless links. In a further embodiment, the wireless interface adapter 230 may operate the two or more wireless links with a single, shared communication frequency band such as with the 5G standard relating to unlicensed wireless spectrum for small cell 5G operation or for unlicensed Wi-Fi WLAN operation in an example embodiment. For example, a 2.4 GHz/2.5 GHz or 5 GHz wireless communication frequency bands may be apportioned under the 5G standards for communication on either small cell WWAN wireless link operation or Wi-Fi WLAN operation. In some embodiments, the shared, wireless communication band may be transmitted through one or a plurality of antennas or antennas may be capable of operating at a variety of frequency bands.

The wireless interface adapter 230 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, or similar wireless standards may be used. Wireless interface adapter 230 may connect to any combination of macro-cellular wireless connections including 2G, 2.5G, 3G, 4G, 5G or the like from one or more service providers. Utilization of radiofrequency communication bands according to several example embodiments of the present disclosure may include bands used with the WLAN standards and WWAN carriers which may operate in both licensed and unlicensed spectrums. For example, both WLAN and WWAN may use the Unlicensed National Information Infrastructure (U-NII) band which typically operates in the ~5MHz frequency band such as 802.11 a/h/j/n/ac/ax (e.g., center frequencies between 5.170-7.125 GHz). WLAN, for example, may operate at a 2.4 GHz band, 5GHz band, and/or a 6 GHz band according to, for example, Wi-Fi, Wi-Fi 6, or Wi-Fi 6E standards. WWAN may operate in a number of bands, some of which are proprietary but may include a wireless communication frequency band. For example, low-band 5G may operate at frequencies similar to 4G standards at 600-850 MHz. Mid-band 5G may operate at frequencies between 2.5 and 3.7 GHz. Additionally, high-band 5G frequencies may operate at 25 to 39 GHz and even higher. In additional examples, WWAN carrier licensed bands may operate at the new radio frequency range 2 (NRFR1), NFRF2, bands, and other known bands. Each of these frequencies used to communicate over the network 254 may be based on the radio access network (RAN) standards that implement, for example, eNodeB or gNodeB hardware connected to mobile phone networks (e.g., cellular networks) used to communicate with the information handling system 200. In the example embodiment, mobile device 200 may also include both unlicensed wireless RF communication capabilities as well as licensed wireless RF communication capabilities. For example, licensed wireless RF communication capabilities may be available via a subscriber carrier wireless service operating the cellular networks. With the licensed wireless RF communication capability, a WWAN RF front end of the information handling system 200 may operate on a licensed WWAN wireless radio with authorization for subscriber access to a wireless service provider on a carrier licensed frequency band.

The wireless interface adapter 230 can represent an add-in card, wireless network interface module that is integrated with a main board of the information handling system or integrated with another wireless network interface capability, or any combination thereof. In an embodiment the wireless interface adapter 230 may include one or more radio frequency subsystems 230 including transmitters and wireless controllers for connecting via a multitude of wireless links. In an example embodiment, an information handling system may have an antenna system transmitter for 5G small cell WWAN, Wi-Fi WLAN or WiGig connectivity and one or more additional antenna system transmitters for macro-cellular communication. The radio frequency subsystems 230 include wireless controllers to manage authentication, connectivity, communications, power levels for transmission, buffering, error correction, baseband processing, and other functions of the wireless interface adapter 230.

The information handling system 200 may further include a power management unit (PMU) 250 (a.k.a. a power supply unit (PSU)). The PMU 250 may manage the power provided to the components of the information handling system 200, e.g., the CPU 204, the GPU 206, the NPU 208, the main memory 210, the static memory 212, the drive unit 214, the output device 220, the input device 222, the wireless interface adapter 230, any combination thereof, and any other components that may require power when a power button on the information handling system 200 is actuated by a user. In an embodiment, the PMU 250 may monitor power levels and be electrically coupled to the information handling system 200 to provide this power and coupled to bus 208 to provide or receive data or instructions. The PMU 250 may regulate power from a power source such as a battery 252 or A/C power adapter 254. In an embodiment, the battery 252 may be charged via the A/C power adapter 254 and provide power to the components of the information handling system 200 when A/C power from the A/C power adapter 254 is removed.

FIG. 2 further indicates that the information handling system 200 includes an operating system (OS) 260, a basic input/output system (BIOS) firmware/software 262, one or more application programs, or a combination thereof that may be part of the computer executable code 218 that is executed at the CPU 204, the GPU 206, the NPU 208, or a combination thereof, and stored the main memory 210, the static memory 212, the computer readable medium 216 of the drive unit 214, or any combination thereof. The BIOS firmware/software 262 functions to initialize information handling system 200 on power up, to launch the OS 260, and to manage input and output interactions between the OS 260 and the other elements of information handling system 200. In a particular embodiment, BIOS firmware/software 262 resides in the main memory 208 or the static memory 212, and includes machine-executable code that is executed by the CPU 204 to perform various functions of information handling system 200 as described herein. In another embodiment (not illustrated), application programs and BIOS firmware/software 262 can reside in another storage medium of information handling system 200. For example, application programs and BIOS firmware/software 262 can reside in the drive unit 214, in a ROM (not illustrated) associated with information handling system 200, in an option-ROM (not illustrated) associated with various devices of information handling system 200, in a storage system (not illustrated) associated with network channel of the wireless interface adapter 230, in another storage medium of information handling system 200, or a combination thereof. It is to be understood that computer executable code 218 for application programs and BIOS firmware/software 238 can each be implemented as single programs, or as separate programs carrying out the various features as described herein.

As stated above, the information handling system 200 may connect to the external wireless network 232. In particular, the wireless network 232 may have a wireless mesh architecture in accordance with mesh networks described by the wireless data communications standards or similar standards in some embodiments but not necessarily in all embodiments. The wireless interface adapter 230 may connect to the external wireless network 233 via a WPAN, WLAN, WWAN or similar wireless switched Ethernet connection in some embodiments. The wireless data communication standards set forth protocols for communications and routing via access points, as well as protocols for a variety of other operations. Other operations may include handoff of client devices moving between nodes, self-organizing of routing operations, or self-healing architectures in case of interruption.

In some embodiments, software, firmware, dedicated hardware implementations such as application specific integrated circuits, programmable logic arrays and other hardware information handling systems can be constructed to implement one or more of the methods described herein. Applications that may include the apparatus and systems of various embodiments can broadly include a variety of electronic and computer systems. One or more embodiments described herein may implement functions using two or more specific interconnected hardware modules or information handling systems with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a controller or a processor system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 216 that includes computer executable code 218 (e.g., instructions, parameters, and profiles), or receives and executes computer executable code 218 (e.g., instructions, parameters, and profiles) responsive to a propagated signal; so that a device connected to the wireless network 232 can communicate voice, video or data over the wireless network 232. Further, the computer executable code 218 may be transmitted or received over the wireless network 232 via the network interface device, i.e., the wireless interface adapter 230.

The wireless interface adapter 230 represents a network interface card (NIC) disposed within information handling system 200, on a main circuit board of the information handling system 200, integrated onto another component such as the CPU 204, in another suitable location, or a combination thereof. The wireless interface adapter 230 can include another information handling system, a data storage system, another network, a grid management system, another suitable resource, or a combination thereof. In an embodiment, the wireless interface adapter 230 may operably connect to the network 232. The connection to network 232 may be wired or wireless.

The network interface device shown as wireless interface adapter 230 can provide connectivity to the network 232, such as a wide area network (WAN), a local area network (LAN), wireless local area network (WLAN), a wireless personal area network (WPAN), a wireless wide area network (WWAN), or another network. Connectivity may be via wired or wireless connection. The wireless interface adapter 230 may include an adaptive massive MIMO Multiplexer with transmitter/receiver circuitry, wireless controller circuitry, amplifiers and other circuitry for wireless communications. The wireless interface adapter 230 may also include antenna systems 236 as described above which may be tunable antenna systems for use with the system and methods disclosed in the embodiments herein. The antenna controller 240 may also include wireless controllers to manage authentication, connectivity, communications, power levels for transmission, buffering, error correction, baseband processing, and other functions of the wireless interface adapter 230.

The information handling system 200 can include a set of computer executable code 218 that can be executed to cause the information handling system 200 to perform any one or more of the methods or computer-based functions disclosed herein. For example, computer executable code 218 may execute various software applications, software agents, or other aspects or components. Various software modules comprising application computer executable code 218 may be coordinated by the OS 260, and/or via an application programming interface (API). An example operating system may include Windows ®, Android ®, and other OS types known in the art. Example APIs may include Win 32, Core Java API, or Android APIs.

The drive unit 214 may include a computer-readable medium 216 in which one or more sets of computer executable code 218 such as software can be embedded to be executed by the CPU 204, the GPU 206, the NPU 208, or a combination thereof, to perform the processes described herein. Similarly, main memory 204 and static memory 206 may also contain a computer-readable medium for storage of one or more sets computer executable code 218 (e.g., instructions, parameters, or profiles). The drive unit 214 or static memory 212 also contain space for data storage. Further, the computer executable code 218 may embody one or more of the methods or logic as described herein. In a particular embodiment, the computer executable code 218 may reside completely, or at least partially, within the main memory 204, the static memory 206, and/or within the disk drive 216 during execution by the CPU 204 of the information handling system 200. The CPU 204, the GPU 206, and the NPU 208 also may include computer-readable media. The NPU 208 may include computer executable code 218 that includes an artificial intelligence (AI) application security module.

The main memory 208, the static memory 212, or other memory of the embodiments described herein may contain computer-readable medium (not shown), such as RAM. An example of main memory 208 can include random access memory (RAM) such as static RAM (SRAM), dynamic RAM (DRAM), non-volatile RAM (NV-RAM), or the like, read only memory (ROM), another type of memory, or a combination thereof. The static memory 212 may contain computer-readable medium (not shown), such as NOR or NAND flash memory in some example embodiments. The drive unit 214 may include access to a computer-readable medium 216 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In other embodiments, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

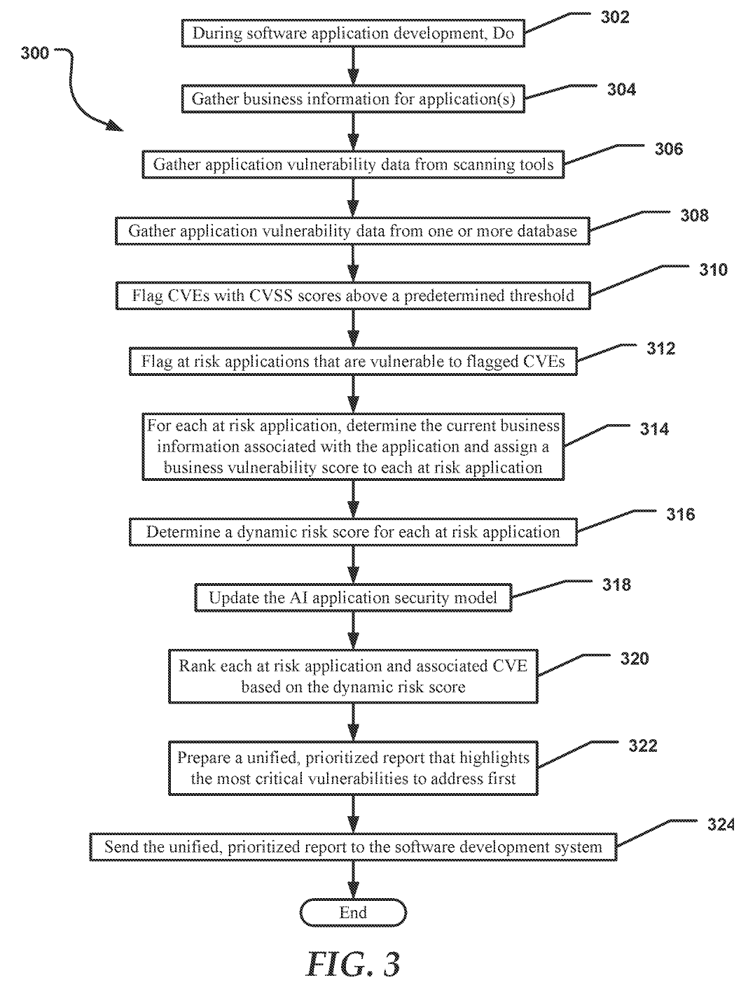

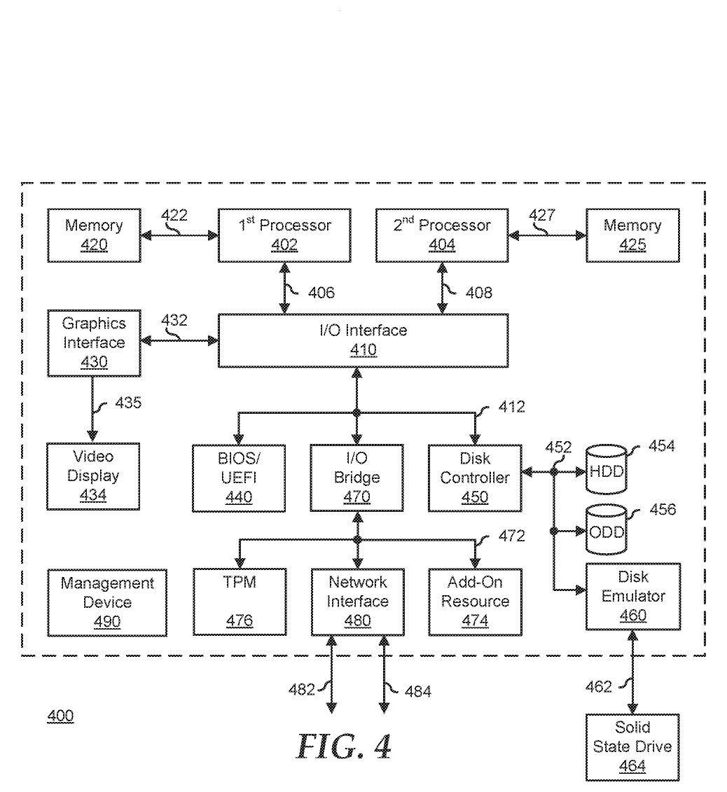

FIG. 3 illustrates a flow diagram of a method 300 of using artificial intelligence to prioritize security risks in a software development system. The method 300 may be performed, for example, in an information handling system that is configured according to at least one embodiment of an information handling system that is described in the present disclosure and the method 300 commences at block 302. It will be readily appreciated that not every method step set forth in this flow diagram is always necessary, and that certain steps of the methods may be combined, performed simultaneously, in a different order, or perhaps omitted, without varying from the scope of the disclosure. The method steps depicted in FIG. 3 may be executed, or employed in whole, or in part, by any of the processors disclosed herein, any other type of controller, device, module, processor, or any combination thereof, operable to employ, or otherwise execute, all, or portions of, the method 300 of FIG. 3.

Beginning at block 302, the method 300 includes entering a do loop wherein during software application development, the following steps are performed. At block 304, the method 300 may include gathering business information for one or more application. In an embodiment, the business information includes a criticality assessment value, an environmental assessment value, an exposure assessment value, or a combination thereof. The criticality assessment value includes a critical value or a not critical value and the critical value is higher than the not critical value. For example, the critical value is plus one (1) and not critical value is negative one (-1). The environmental assessment value includes a production value or a staging value and the production value is higher than the staging value. For example, the production value is plus one (1) and the staging value is negative one (-1). Finally, the exposure assessment value may include a public system value or internal system value and the public system value is greater than the internal system value. For example, the public system value is plus one (1) and the internal system value is negative one (-1).

Moving to block 306, the method 300 includes gathering application vulnerability data from scanning tools. Further, at block 308, the method 300 includes gathering application vulnerability data from one or more databases. The application vulnerability data includes one or more common vulnerability and exposure (CVE) items having an associated common vulnerability scoring system (CVSS) score. The CVE items may be available at a CVE database, e.g., an external database. At block 310, the method 300 can include flagging CVEs that have a CVSS score above a predetermined threshold. For example, in the case of a CVSS scoring system of zero to ten (0 – 10), all CVEs having a CVSS score of seven (7) or greater may be flagged. At block 312, the method 300 can include flagging at risk applications that are vulnerable to the flagged CVEs.

Proceeding to block 314, the method 300 includes, for each at risk application, determining the current business information associated with the at risk applications and assign a business vulnerability score to each at risk application. The business information is similar to the business information described above and the business vulnerability score may be, for example, a summation of the criticality assessment value, the environmental assessment value, the exposure assessment value. As such, the business vulnerability score may be a number between, and including, negative three (-3) and positive three (3).

At block 316, the method 300 can include determining a dynamic risk score for each at risk application. For example, the dynamic risk score may be determined based on the business vulnerability score and the CVSS score. In other words, the dynamic risk score for each at risk application may be based on the CVSS score, the criticality assessment value, the environmental assessment value, the exposure assessment value, or any combination thereof. For example, a CVE with a CVSS score of ten (10) may be dynamically modified by a value of negative three (-3) to positive three (3). That is if a first CVE with a first CVSS score of ten (10) is targeted toward a first at risk application that is not critical (criticality assessment value = -1), that is currently in a staging phase (environmental assessment value = -1), and is an internal system application (exposure assessment value = -1), the dynamic risk score would be equal to the first CVSS score of ten (10) minus three (3) and would equal seven (7). Further, if a second CVE with a second CVSS score of seven (7) is targeted toward an at risk application that is critical (criticality assessment value = 1), that is currently in a production phase (environmental assessment value = 1), and is a public system application (exposure assessment value = 1), the dynamic risk score would be equal to the second CVSS score of seven (7) plus three (3) and would equal ten (10). As such, the second CVE and the associated second at risk application would be elevated above the first CVE and the associated first at risk application and that issue with respect to the second CVE and the second at risk application can be addressed prior to the first CVE and the first at risk application.

Continuing to block 318, the method 300 can include updating the AI application security model with the information determined above. At block 320, the method 300 can include ranking each flagged application and associated CVE based on the dynamic risk score determined above. Then, at block 322, the method 300 includes preparing a unified, prioritized report that highlights the most critical vulnerabilities to address first. Finally, at block 324, the method 300 can include sending the unified, prioritized report to the software development system, e.g. the CI/CD pipeline. That system may transmit the report to the appropriate user, or software coder. The method may then end.

FIG. 4 shows a generalized embodiment of an information handling system 400 according to an embodiment of the present disclosure. Information handling system 400 may be substantially similar to the information handling system 100 of FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below and operates to perform one or more of the methods described herein. Information handling system 400 includes a processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456 , a disk emulator 460 connected to an external solid state drive (SSD) 464, an I/O bridge 470, one or more add-on resources 474, a trusted platform module (TPM) 476, a network interface 480, a management device 490, and a power supply 495. Processors 402 and 404, I/O interface 410, memory 420, graphics interface 430, BIOS/UEFI module 440, disk controller 450, HDD 454, ODD 456, disk emulator 460, SSD 464, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432 and provides a video display output 436 to a video display 434. In a particular embodiment, information handling system 400 includes separate memories that are dedicated to each of processors 402 and 404 via separate memory interfaces. An example of memories 420 and 425 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 4394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412 or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400.

Management device 490 can operate off of a separate power plane from the components of the host environment so that the management device receives power to manage information handling system 400 when the information handling system is otherwise shut down. An example of management device 490 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed, or desired.

The systems and methods described herein utilize an AI model to rank vulnerabilities not just on severity, but on contextual factors like business value and real-world exposure. Further, the AI model continuously adapts to infrastructure changes and learns from historical vulnerability resolutions. The systems and methods described herein substantially reduce a time to remediation and allows teams focus on the most critical vulnerabilities, reducing manual triaging and improving efficiency. Moreover, high-impact vulnerabilities are addressed faster, minimizing the risk of breaches. Also, the systems and methods herein provide for reduced labor for vulnerability management and the quicker fixes lead to cost savings.

In general, the architecture of the system includes an input layer, an AI prioritization engine, and an output layer. The input layer utilizes input from multiple tools (e.g., Checkmarx, SonarQube, Prisma Cloud) feeding raw vulnerability data. Further, the input layers utilizes external data that includes continuous integration with one or more external CVE databases and threat intelligence sources. The input layer also include infrastructure information that includes input from the CI/CD pipeline and/or other automation about the infrastructure/cloud details. The AI prioritization engine conducts data aggregation and collects inputs from the vulnerability tools and merges those inputs with infrastructure, application, and business context data. The AI prioritization engine is a contextual model that applies contextual factors (e.g., application criticality, cloud exposure, exploit data) to prioritize vulnerabilities. The AI prioritization engine is also a dynamic learning module that learns from previous vulnerability resolutions and as such, improves prioritization over time. The output layer provides unified report generation and sends a prioritized vulnerability report back to security engineers or CI/CD tools. Further, the output layer provides automation hook that optionally integrates with remediation automation tools to trigger fixes based on prioritized vulnerabilities.

### Real World Examples

Example 1: Prioritizing Critical Application Vulnerability

Scenario: A vulnerability scanner detects several CVEs across a company's applications. One CVE has a CVSS score of 9.0 (critical), but it affects a non-public, internal development environment. Another CVE with a score of 7.0 affects a high-traffic, customer-facing web application.

AI-Powered Prioritization: The system deprioritizes the internal vulnerability and pushes the CVE affecting the customer-facing app to the top, based on business impact and exposure.

Outcome: The team fixes the high-impact CVE first, preventing potential breaches on a public app while deprioritizing the less important internal issue.

Example 2: Infrastructure Exposure Influencing Prioritization

Scenario: Two vulnerabilities are detected on different servers. One affects a production server exposed to the internet, and the other affects an internal server with limited access.

AI-Powered Prioritization: The AI model identifies that the production server is more exposed and prioritizes the associated vulnerability despite both vulnerabilities having the same severity score.

Outcome: The production server vulnerability is addressed immediately, reducing the risk of external attacks, while the internal server fix is scheduled for later.

Example 3: Real-Time Reprioritization Based on New CVE Updates

Scenario: A critical vulnerability (CVE-2024-XXXX) is identified in a company's production environment. A patch is deployed, and the risk is mitigated. Meanwhile, a new zero-day vulnerability affecting the same infrastructure is discovered.

AI-Powered Reprioritization: The AI system dynamically reprioritizes this new vulnerability as soon as it’s detected, placing it at the top of the remediation list.

Outcome: Engineers shift focus immediately to address the zero-day vulnerability, ensuring the production environment remains secure.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system, comprising:a computer readable medium including an artificial intelligence (AI) application security model; anda processor operably coupled to the computer readable medium to access the AI application security model to:gather business information for one or more applications;gather application vulnerability data;flag one or more at risk applications based on the application vulnerability data,wherein an application is an at risk application when the application is vulnerable to one or more common vulnerability and exposure (CVE) items;andassign a business vulnerability score for the one or more at risk application at least partially based on the business information for the one or more at risk application;prioritize a first at risk application ofa second at risk application based a first business vulnerability score ofthe first at risk application being higher than a second business vulnerability score ofthe second at risk application; and transmit a prioritized report to a user ofthe information handling system, wherein the prioritized report indicates that the first at risk application is to be addressed before the second at risk application based on the first business vulnerability score ofthe first at risk application being higher than the second business vulnerability score ofthe second at risk application.

2. The information handling system of claim 1, wherein the business information includes a criticality assessment value, an environmental assessment value, an exposure assessment value, or a combination thereof.

3. The information handling system of claim 2, wherein the criticality assessment value includes a critical value wherein the critical value is higher than a not critical value.

4. The information handling system of claim 3, wherein the environmental assessment value includes a production value wherein the production value is higher than a staging value.

5. The information handling system of claim 4, wherein the exposure assessment value includes a public system value wherein the public system value is greater than aninternal system value.

6. The information handling system of claim 5, wherein the application vulnerability data includes theone or more CVE items having an associated common vulnerability scoring system (CVSS) score.

7. The information handling system of claim 6, wherein the processor further accesses the Al application security model to:determine a business vulnerability score for each at risk application based on the criticality assessment value, the environmental assessment value, the exposure assessment value, or any combination thereof.

8. The information handling system of claim 7, wherein the processor further accesses the Al application security model to:determine a dynamic risk score for each at risk application based on the CVSS score and the business vulnerability score.

9. The information handling system of claim 8, wherein the processor further accesses the Al application security model to:rank each at risk application and associated CVE item based on each dynamic risk score.

10. A method of prioritizing security risks in a software development system using an artificial intelligence (Al) application security model, the method including:gathering business information for one or more applications;gathering application vulnerability data;
flagging one or more at risk applications based on the application vulnerability data, wherein an application is an at risk application when the application is vulnerable to one or more common vulnerability and exposure (CVE) items;
assigning a business vulnerability score for the one or more at risk application at least partially based on the business information for the one or more at risk application;
prioritizing a first at risk application of a second at risk application based a first business vulnerability score of the first at risk application being higher than a second business vulnerability score of the second at risk application; and transmitting a prioritized report to a user of the information handling system,wherein the prioritized report indicates that the first at risk application is to be addressed before the second at risk application based on the first business vulnerability score of the first at risk application being higher than the second business vulnerability score of the second at risk application.

11. The method of claim 10, wherein the business information includes a criticality assessment value, an environmental assessment value, an exposure assessment value, or a combination thereof.

12. The method of claim 11, wherein the criticality assessment value includes a critical value wherein the critical value is higher than a not critical value.

13. The method of claim 12, wherein the environmental assessment value includes a production value wherein the production value is higher thana staging value.

14. The method of claim 13, wherein the exposure assessment value includes a public system value wherein the public system value is greater than aninternal system value.

15. The method of claim 14, wherein the application vulnerability data includes theone or more CVEitems having an associated common vulnerability scoring system (CVSS) score.

16. The method of claim 15, further comprising:determining a business vulnerability score for each at risk application based on the criticality assessment value, the environmental assessment value, the exposure assessment value, or any combination thereof.

17. The method of claim 16, further comprising:determining a dynamic risk score for each at risk application based on the CVSS score and the business vulnerability score; andranking each at risk application and associated CVE item based on each dynamic risk score.

18. An information handling system, comprising:a computer readable medium including an artificial intelligence (Al) application security model; anda processor operably coupled to the computer readable medium to access the Al application security model to:gather common vulnerabilities and exposures (CVEs);flag CVEs having associated common vulnerability scoring system (CVSS) scores above a predetermined threshold;flag applications that are at risk to the CVE items, wherein an application is an at risk application when the application is vulnerable to one or more CVE items;and determine a business vulnerability score for each at risk application based on a criticality assessment value, an environmental assessment value, an exposure assessment value, or any combination thereof;prioritize a first at risk application of a second at risk application based a first business vulnerability score of the first at risk application being higher than a second business vulnerability score of the second at risk application; and
transmit a prioritized report to a user of the information handling system, wherein the prioritized report indicates that the first at risk application is to be addressed before the second at risk application based on the first business vulnerability score of the first at risk application being higher than the second business vulnerability score of the second at risk application.

19. The information handling system of claim 18, wherein the processor further accesses the Al application security model to:determine a dynamic risk score for each at risk application based on the CVSS score and the business vulnerability score.

20. The information handling system of claim 18, wherein the processor further accesses the Al application security model to:rank each at risk application and associated CVE item based on each dynamic risk score.
